(19) United States
(12) Patent Application Publication
(10) Pub. No.: US 2012/0298526 A1
(43) Pub. Date: Nov. 29, 2012

(54) METHOD AND APPARATUS FOR ELECTROCHEMICAL TREATMENT OF CONTAMINATED WATER OR WASTEWATER

(75) Inventor: Erkki HÄIVÄLÄ, Hyvinkaa (FI)

(73) Assignee: Atlantis Life Systems Incorporated, Lake Worth, FL (US)

(21) Appl. No.: 13/117,941

(22) Filed: May 27, 2011

(51) Int. Cl. C02F 1/463; C25B 11/02; C25B 9/00

(52) U.S. Cl. 205/742; 204/278.5

(57) ABSTRACT

An apparatus for electrochemical treatment of contaminated water or wastewater comprises a container or tank having an inlet and an outlet and a feed pump for the water to be treated, connected to the inlet for supplying the water through the inlet to the container or tank. Parallel pairs of electrode plates are situated in vertical position in the container or tank and form parallel vertical passages therebetween for the water to be treated. In the pairs of electrode plate at least one electrode plate comprises holes connected to a feed pump for an auxiliary medium. Said pairs of electrode plates are positioned between the inlet and outlet in the container or tank such that in at least part of the flow route between the inlet and outlet the water passes upwards in the vertical passages. The feed pump for the water to be treated and/or the feed pump for the auxiliary medium is a pulsating feed pump.

### FIELD OF THE INVENTION

The present invention relates generally to the field of water and wastewater treatment systems, an in particular to systems utilizing an electrochemical cell to facilitate flocculation of particles in the water or wastewater to permit the discharge of treated wastewater to the environment or purification of potable water.

The invention relates to the method for electrolytic treatment of liquids, for example liquid containing reactants, such as wastewater containing solids or liquid to be separated from water and/or containing substances to be decomposed or to be made innocuous. This liquid is passed between two plate-like electrodes of opposite charge having their operative surfaces opposed to each other and forming a reaction area. The reaction area is effectively controlled with special and purposeful flowing arrangements. The invention relates also to an apparatus for carrying out such a method.

### BACKGROUND OF THE INVENTION

One of the major challenges facing environmental scientists today is to provide clean water to the population around the world. Rivers, canals and other water-bodies are being constantly polluted due to indiscriminate discharge of industrial effluents as well as other anthropogenic activities and agricultural use. Also, geochemical processes or mining activities have contaminated ground water with arsenic, fluorine or heavy metals in many countries. An ever increasing population, urbanization and climatic changes are responsible that the reuse of wastewater has become an absolute necessity as well as the local purification of raw water. There is, therefore, an urgent need to develop innovative, more effective and inexpensive techniques for treatment of wastewater, and also purification of potable water.

Chemical procedures have attempted to cause a predetermined reaction between chemical additives and impurities contained within the waste stream. The most common reactions are designed to cause the impurities and the chemical additives to coagulate, wherein the particles increase in size and then separate by either floating up or settling below the treated water. The most popular chemicals utilized for coagulation are alum and some ferrous/ferric salts which, when added to the wastewater, separates much of the wastes out of the water. There are, however, several problems with chemical coagulation in general, including the generation of very large quantities of residuals that need to be disposed and imprecision because of the amount of a chemical necessary for a given volume must always be estimated due to the varying nature of the waste streams.

Many industrial chemical effluents and naturally existing elements are, however, refractory (i.e. resistant) to standard chemical procedures. There has been a growing worldwide interest to use diverse electrolytic methods for treating certain types of process waters derived from tannery, electroplating, dairy, textile processing, oil and oil-in-water emulsion, various bio-organic wastewaters, or even drinking water.

Electrochemical technologies have advanced and are comparable with other technologies in terms of cost, efficiency and size. For some situations, electrochemical technologies is the indispensable step in treating wastewaters containing refractory pollutants.

It has turned out, that the electrochemical processes are efficient, but their rates are often limited by convective terms, like diffusion or transport of reactants or products. Thus, it is obvious that efficient mixing, especially near the electrodes, is one key phenomenon to be solved, when the overall kinetics is to be affected. In the electrolytic purification process, it is hard to design reactor/electrode systems, which take into account all the aspects of this complicated application, i.e. the presence of chemical or electrochemical reaction, the simultaneous, efficient use of electricity, and the flow characteristics of the homogeneous, often flock laden formatting flux. Many of the suggested constructions suffer complexity and are obviously useless in practical situations because of clogging or even short-circuiting the space between the electrodes. The size and charges of the formed bubbles, especially micro-bubbles are of utmost importance in electroflotation. For example, U.S. Pat. No. 3,969,203 and U.S. Pat. No. 3,969,245 for Ramirez shows that the bubble size of 30-200 microns is advantageous in removal of oily organic material.

Small gas bubbles are used in many environmental and industrial processes for solid-liquid separations. Typically, smaller bubbles are preferred in the beginning with some treatment techniques due to both their high surface area-to-volume ratio and their increased bubble density at a fixed flow rate. Small debris like clays, organic microbes, emulsion oil droplets, bacteria, and even ions, in the water phase has been stubborn to remove by mechanical means. Therefore, electrolytic and electrocoagulation methods are the answer. In conclusion: The size of the micro-bubbles in electroflotation and from smooth anodes and cathodes seems to be about 10 to 30 microns. This is very advantageous in many applications. On the other hand, those small bubbles have a restricted capability to float with larger particles, flocks or coagulates and there is an obvious need to utilize the bigger bubbles with higher buoyancy forces.

On most electrocoagulation installations the surfaces of the electrode plates are not utilized optimally. In a flow between the electrodes, a diffusion layer is generated in the proximity of each electrode, which makes the diffusion of reactants onto the operative surface and diffusion of the products difficult. Moreover, gases generated by the electrolysis reduces the operative surface of the electrodes and they must be quickly removed from the surface.

The object of the invention in U.S. Pat. No. 5,022,974 to Erkki Haivala was to overcome the disadvantages referred to above and to provide a method and an apparatus by means of which the conditions between the electrodes are controlled. The operative area of the electrode surfaces (and also the reactor volume) can be effectively used in this invention. Also, the invention removes diffusion layers, gaseous layers and deposited layers on the surfaces of the electrodes, which all tend to reduce the overall efficiency of the process.

A further object of the invention of the U.S. Pat. No. 5,022,974 was to create a practical arrangement for introducing reactants into the reaction area between the electrodes, which arrangement can be used e.g. in electrolytic decomposition of cyanide or other harmful species or simply increase the conductivity of the treated solution.

There have been attempts to overcome these disadvantages by agitating the liquid before it is introduced into the passage between the plates. The conditions between the electrode plates are, however, not controlled sufficiently by this procedure. The passages between the plates are long and narrow, which is advantageous for the constructional simplicity and the efficiency of the electric current and overall residence time. Other suggested applications has been to disperse the flow by using inert porous mesh construction as turbulence promoter between the electrodes or even rotating mechanical turbulence generators like in U.S. Pat. No. 6,099,703 to Syversen et. al. Various detrimental influences have been reported. Some of the electrode systems are so complicated that simple free flowing is not possible and can easily get fouled and clogged, even short circuiting the electrodes.

On the other hand, a reasonable reaction time for all reactions is desired in the reaction area. The time varies from seconds to tenths of a minute and in some cases to minutes. This means that the main wastewater flow must be basically laminar in its main direction between the electrodes. There is a need to avoid too much shearing because of the stability of the formed flock.

### SUMMARY OF THE INVENTION

It is an object of the invention to provide an improved process for processing or treating waste water or household water, to improve the efficiency of elimination of harmful and toxic substances, reduce energy consumption, and improve electrode life.

It is a further object of the invention to provide an improved process which is efficient in all aspects and is free from drawbacks of prior systems as described earlier.

Further, it is one object of the invention to provide an improved apparatus for carrying out the process of the invention.

Further, it is one object of the invention to control the size of the generated bubbles, i.e., to optimize the size of the forming microbubbles.

As a summary, it is the object of the invention to provide a simple yet efficient method for treatment of contaminated water or wastewater and to provide a compact apparatus for performing the method.

The apparatus comprises a container or tank having an inlet for the liquid to be treated and outlet for the treated liquid, a supply pump of the liquid to be treated operatively connected to the inlet, and parallel pairs of electrode plates in vertical position inside the container or tank and parallel vertical passages formed between the pairs of electrode plates, said vertical passages forming flow path for the liquid to be treated between the inlet and the outlet. At least one of the plates of the pair of electrode plates comprises holes which are operatively connected to a supply pump of a medium. The pairs of electrode plates are placed between the inlet and outlet in the container or tank such that at least part of the flow path of the liquid to be treated is directed from the bottom to the top. The supply pump of the liquid to be treated and/or the supply pump of the medium is a pulsating supply pump.

The pairs of electrode plates are preferably adjustable in vertical direction and fixable at least two different positions to alter the flow path within the tank or container to optimise the process conditions with regard to residence time, side reactions etc. By individual adjustments of the pairs of electrode plates vertically it is possible to change the upward flow path of the liquid at least partially from parallel flow (liquid volume to be treated simultaneously through several parallel vertical passages) to a serial one (liquid volume to be treated successively through several vertical passages).

One particular object of the invention is still to provide an apparatus with a compact pump for supplying auxiliary medium to the electrodes of the apparatus and for pumping water to be treated through the apparatus. The piston of the pump is driven by a rotating ring-like member surrounding the piston which is arranged non-rotatable in a pumping chamber. The ring transmits the rotating motion to the reciprocating pumping motion of the piston through a cam-like member which is attached to the inner side of the ring and circulates the piston along with the rotating movement of the ring around the piston while engaging a waveform guide groove extending around the piston in the peripheral direction and being fixedly attached to the piston.

By means of the present invention, it is possible to control both the flow rate of the main waste stream to be within the desired rate of the reaction kinetics and simultaneously control the cross feed turbulence and efficient mixing. The flow regimens in the reactor create an optimal possibility for the flock to grow up to the optimal size and thus float and collect the impurities in the treated waste water effectively.

Another advantage is that when controlling the flow characteristics in the electrolysis cell in a precise manner in the direction against the electrode surfaces, the flow cleans up the working electrode surfaces, greatly improving the efficiency of the electrolysis and thus lowers the operating costs.

The benefits of a special and programmed/controlled flow to the electrode reactions by adjusting and controlling both flow rates (i.e. the main waste stream through the apparatus and the cross flowing pulsating and turbulent stream of the auxiliary medium) together, will optimize full and effective mixing and use of all the reactor volume.

An important feature of this invention is that the electrodes have a large surface area. Due to the high electrode cell area, as compared to prior systems, the current density can be maintained at a low level while still achieving effective flotation. The combination of high cell area and low interelectrode separation and effective crossflow turbulence results in the microbubbles being widely dispersed from the moment they are created; causing mixing and dispersing concentrated microbubbles into the waste water flow, where the bubbles adhere to the impurities in the waste water. This results in extremely efficient removal of suspended impurities from the wastewater. As a result, the electrolytic flotation system of this invention requires substantially less power than prior electrolytic flotation devices. It is typically more efficient in the removal of floated impurities than the prior electrolytic flotation systems.

The construction of the set of electrolysis cells remains relatively straightforward and simple, thus lowering the installation and service costs.

In conclusion, the application of the present invention overcomes the disadvantages referred to hereinabove and provides a method and an apparatus to solve the conditions between the electrodes and the operative area of the electrode surfaces and the reactor volume which can be effectively controlled. The apparatus assists in removing diffusion layers, gaseous layers and deposited layers on the surfaces of the electrodes which in previous prior art is not known.

The present invention controls the parameters of flushing the system in a controlled manner using the electrodes. This apparatus will be able to affect the phenomena, like the released bubble size and the released coagulate flock size to enhance the overall kinetics of the processes. By predetermined and controlled flows in one or both directions (i.e. parallel with the electrodes and substantially turbulent crossflow via holes in the electrodes) it is possible to affect the bubble size and flock size. In a controlled way starting from tiny bubbles and allowing them to grow up to the desired level, it can generate a much more efficient use of the reactor volume and removal of the product substances. Additional benefit is that there is a fully controlled mixing in the reactor volume, despite of the relatively slow laminar plug flow in parallel (with electrodes) direction, which will ensure the reasonable residence time for all the electrochemical reactions and flock aggregation.

The present invention answers these questions, because it solves the problems on how to utilize the whole reactor volume, how to gain maximum use of the electrode area, how to simultaneously maintain the maximum efficiency to form and control the microbubbles and flock generation and aggregation, respectively, which is needed to absorb and remove the products and pollutants. Due to the depositing impurities of the wastewaters fouling the operative surfaces, this invention solves the problem of it collecting in the corners or pockets.

The method is carried out by means of an apparatus which introduces an auxiliary medium into the reaction area. This is separate from the main flow of the liquid (contaminated water or wastewater) to be treated on the surfaces of the electrodes. Actually, every electrode, being constructed as a closed casing with the help of two parallel electrode plates spaced form each other so that an interior space is formed between them, will act as a pressure chamber for said medium, from which the medium purges as a jet like pulse and mixes with the main water flow. By this arrangement the flow of the medium creates a strong local and periodical turbulence or swirl, which contributes to a better mixing of the components within the local reaction volume between the electrodes, thus enhancing the rate of various reactions between the components, and at the same time breaking and removing any layers, which might decrease the rate of the electrolytic reactions on the surfaces. The pulses are generated outside of the electrolysis cell by known hydromechanical means like piston pumps or peristaltic pumps, solenoid valves or by other suitable hydraulic means. Thus, there is a continuous control for the both flow regimens, the main waste flow and the pulsating crossflow through the electrode.

According to a further advantageous embodiment of the invention, the auxiliary medium in the electrodes can be an electrolyte containing dissolved components participating in the reactions in the reaction area. When this method is applied, the invention can be used at the same time in dosing specific reactants into the reaction area. In case the medium is a solution containing electrolytes, the electric conductivity of the liquid can be increased, if not high enough. According to the same principle, e.g. sodium chloride can be dosed into the reaction area for electrolytic oxidation of cyanide. A neutralization or precipitation agent, or even flocculants, can be dosed as well. With this arrangement the dosing and mixing is rapid and optimally smooth, which is important in many chemical reactions, e.g. neutralization.

For the person skilled with the art it is obvious that the crossflowing auxiliary medium can, simply, have the same feed composition as the main wastewater or it can be circulated water from the reactor outlet. These arrangements still have the same advantages for mixing and flushing and controlling the microbubble and the flock size distributions as described earlier.

The period and length of the pulse and also its strength is adjustable and it is controlled with respect to the main waste water flow to be treated in such a way that the desired effect can be achieved. For example, when the formed flock size is too big, the pulsating period should decrease and the pulse have more strength (i.e. pressure) to break up too big flock aggregates. Also, if the opposite electrode is becoming dirty or clogged (which is seen from the operating cell voltages and currents) then both the pulsating frequency and pressure should intensify. Besides, the size of the microbubbles is also affected by the current density of the electrolysis current. According to the invention, at least one of the electrode plates in the apparatus is comprised of holes perforated therein for introducing the medium from behind the electrode plate into the reaction area. This type of apparatus has an extraordinarily simple construction.

### BRIEF DESCRIPTION OF THE DRAWINGS

The following detailed description will be better understood when read in conjunction with the appended drawings, where

FIG. 1 is a detailed view of the electrodes used in the present invention, both the anodes and cathodes using the same construction;

FIG. 2 is a perspective assembly view of the electrocoagulation reactor cell apparatus of the present invention, where the main water flow goes upwards in parallel with all the electrodes;

FIG. 3 is a detail, which shows how the electrodes are connected to the wall of the reaction chamber to maintain the possibility of a fluid medium to enter via the electrode into the main reaction volume;

FIG. 4 is another perspective assembly view of the electrocoagulation reactor cell apparatus of the present invention, where the main wastewater flow goes serially upwards from the bottom between the electrodes, which form a labyrinth like construction;

FIG. 5 shows schematically as a side elevation view the possibility to transform the electrode container or tank of the apparatus from one mode of operation to another mode of operation;

FIG. 6 shows schematically as a side elevation view another possibility to transform the electrode container or tank of the apparatus from one mode of operation to another mode of operation;

FIG. 7 shows schematically as a side elevation view a possibility to remove material separated in the electrode container or tank and material separated in the clarification container following the electrode container or tank;

FIG. 8 shows schematically as a side elevation view another arrangement of the electrode container or tank and the clarification container;

FIG. 9 shows a pump of the apparatus as sectional view taken along line IX-IX of FIG. 10;

FIG. 10 shows the pump as an end view; and

FIG. 11 shows the pump as a top plan view in a situation where inlet conduits and outlet conduits are connected to it.

### DETAILED DESCRIPTION OF THE INVENTION

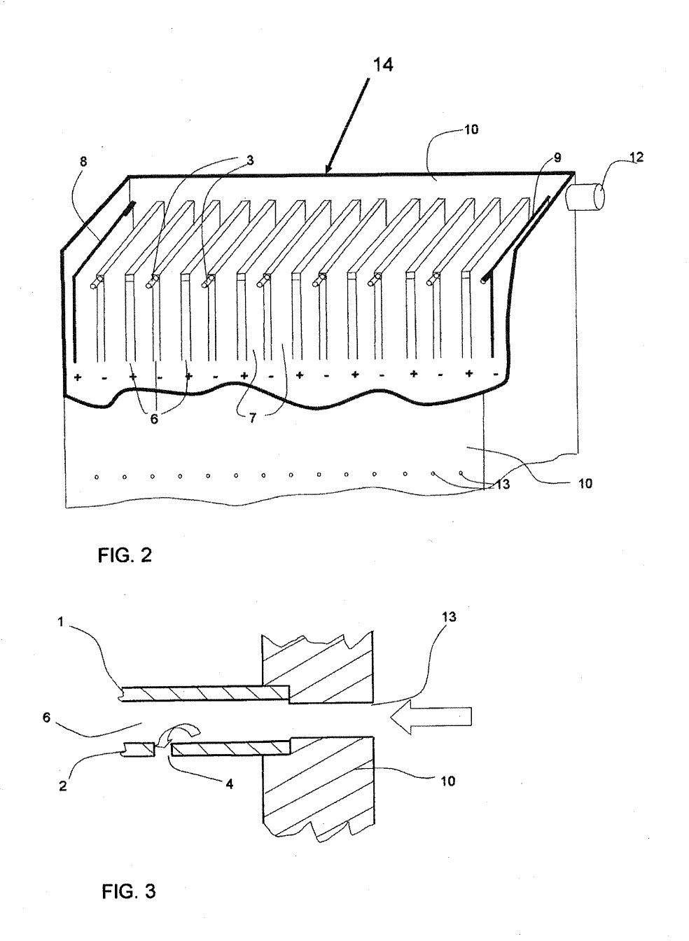

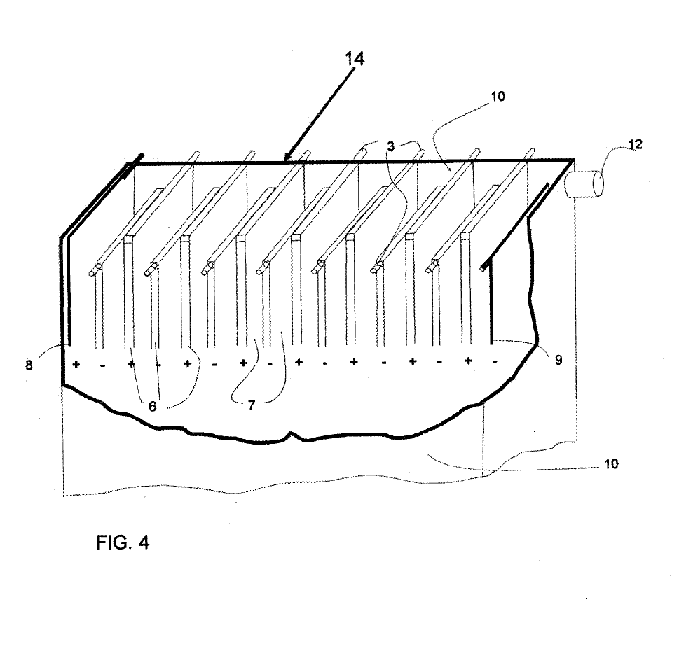

The preferred electrolytic flotation system of the present invention, illustrated in FIGS. 2 and 4, includes a flotation tank 14 with an inlet of wastewater in the bottom corner of tank 14 (not shown in the figures) and an outlet 12 in the top corner for treated water and flock. The flotation tank 14 includes a set of electrodes in vertical position as illustrated in FIGS. 2 and 4. The flow direction of the wastewater in the tank 14 with the electrode construction of the embodiment of FIG. 2 is from bottom to top, and with the electrode construction of FIG. 4 it will vary through the labyrinth construction of the electrode set. The construction of FIG. 2 is preferred when high volume of the wastewater is needed to be treated or processed. The construction of FIG. 4 is needed when the purification process in question is slow and needs additional residence time. The total number of electrodes in the unit is freely selectable, and the electrodes can be connected in parallel to each other with the same polarity. With this construction it is also possible and advantageous to change the polarity of the electrodes frequently, as is discussed many places with the prior art.

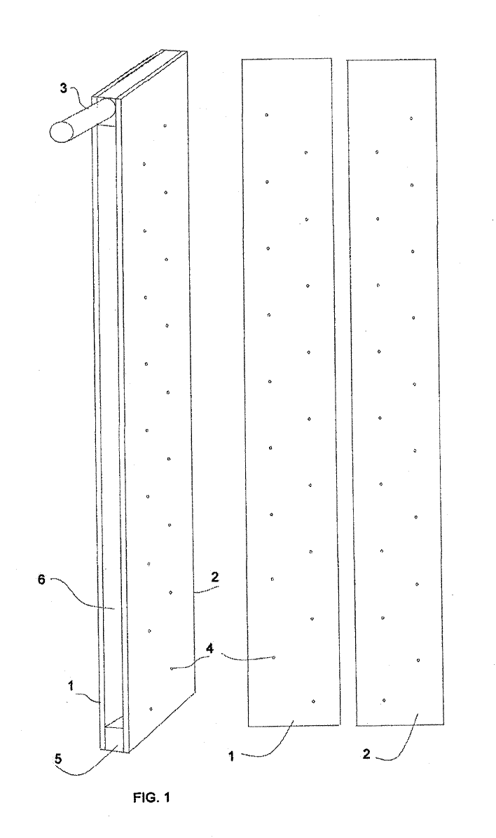

Both the outermost electrodes 8 and 9 in FIGS. 2 and 4 are ordinary plate electrodes. All the middle electrodes have the construction which is illustrated more closely in FIG. 1. The electrode construction of FIG. 1 consists of two parallel electrode plates 1 and 2, which are combined with separators 3 and 5. These separators 3 and 5 are made from conducting material, preferably the same as the plates 2 and 3; they are normally combined together with the separators by known means like screwing, riveting or welding and will form together a hollow electrode construction. Separator 3 can serve as a current conducting pole for the electrode. The electrode is thus formed of two parallel plates 1, 2 of the same polarity (electric charge) joined together to a package with an empty space between the plates. Thus, the package can comprise two anode plates or two cathode plates.

At least one of the plates 1 and 2 will have perforated holes 4, which are formed by perforating the plate material. Often it is preferred to have both plates 1 and 2 with these holes 4, in which case plate 2 is turned around so that there is mirror symmetry between the plates 1 and 2 as illustrated more closely in FIG. 1. Thus, there exists a situation with two adjacent electrodes of this type that the holes are not opposing to each other but each hole 4 is opposing directly a blank electrode plate of the adjacent electrode.

The electrodes are placed tightly in the flotation tank 14, and there is a groove in the tank side walls 10 which will hold them tightly bound in place as is shown in FIG. 3. Thus, the electrodes of FIG. 1 will form together with the walls 10 a totally closed hollow electrode construction. It is also illustrated in FIG. 3, how the flow of the additional fluid medium is arranged through the wall 10 via holes 13 of the wall into the hollow space 6 between the plates 1, 2. It is further illustrated in FIG. 3, how that medium will mix with the main wastewater flow in passages 7 formed between the adjacent electrodes via holes 4 in the plate(s) 1 and 2. The electrodes (plate packages) are placed next to each other so that the electrodes of one polarity alternate with the electrodes of opposite polarity, in which case the passages 7 between the electrodes always are limited by two electrode plates of opposite charges facing each other.

The holes 4 should be arranged so that they are symmetrically dispersed to the plate area. The distribution of the holes 4 in FIG. 1 is only illustrative. The diameter of the holes 4 is normally from 1 to 5 mm, depending among other things on the spacing between adjacent electrodes. The pressure inside the hollow space 6 can be used to control that the fluid jet via holes 4 is high enough to reach and flush efficiently the adjacent electrode in the desired way. The pressure of the chambers 6 can be easily measured and monitored with the semiconductor pressure detectors in the input pipe line 13 or equivalent place in the wall 10 and that pressure information can be used to control the decided pulse strength to affect the adjacent electrode.

Normally the fluid flow through the hollow electrode space 6 is from 5 to 20% of the main flow of wastewater. The flow can contain added chemicals like salt or neutralization agents or even flocculants in certain cases. It is to be noted that it can in principle have different composition within every electrode, which will make the additions of different chemicals possible. The system is nearly ideal for simultaneous neutralization, because the neutralization agent can be added simultaneously and rapidly from plurality of points and the mixing is very rapid.

Obviously, there is no limitation of the electrode material such as steel, iron, aluminum, titanium or coated titanium etc. There are practically no limitations of the size or number of the electrodes. Material thickness of 3 to 10 mm is suitable for the plates 1 and 2. The space between plates 1 and 2 is in the range 5 to 30 mm, and the spacing between the electrodes (width of the passages 7) is 10 to 80 mm. It is to be noted that the spacing between adjacent electrodes is often the main reason for the electric consumption as ohmic drop, especially when the conductivity of the waste water is low.

The material of the tank walls 10 should be rigid and nonconductive. For example PVC is suitable material, especially with thickness over 20 mm. Thus, with the present invention it is possible to control the flow of the fluid material through the hollow electrodes and in various ways to affect the electrolysis reactions to enhance their kinetics and efficiency. Especially important is the control of sizes of the formed microbubbles and flocks as discussed earlier with the background. The size of both the aforementioned variables is near optimum when the pulsating period through the electrodes in continuous use is between 0.2 and 8 seconds depending on the construction and flow rate of the main wastewater flow as well as wastewater type.

Also, it is usually important to periodically wash out the formed scales and debris in the adjacent electrode surfaces, which appearance is shown normally with considerably higher need of energy (i.e. voltage levels) in the electrolysis system. With the electrode configurations of FIGS. 2 and 4 there is possibility to fully control the condition of practically all acting electrode surfaces, even individually, by measuring the currents (and voltage) into each electrode, deciding which is not working properly (i.e. the ones working with lower current levels), and affecting that particular electrode by strong enough pulsating pressures to the inner chamber 6 of the hollow adjacent electrode to remove the scale or debris. Even purifying chemicals like acetic acid or even hydrochloric acid can be directed precisely and controlled way to that abnormal electrode surface. When combined to earlier described capability to change the polarity of the electrodes, these control possibilities and capabilities for serving the electrolysis systems in the electroflotating of the present invention units are not known the prior art technology. Thus, the present invention will help to solve the problems, how to clear the contaminated electrode surfaces and maintain the continuous and efficient use of the purification system.

The fluid medium which is passed through the electrodes can contain chemicals to affect the reactions with the waste water, like chlorides subjected e.g. to destruct cyanides in the galvanizing baths by generating hypochloric acid with aid of the electrolysis or to be used in disinfection purposes for disinfection of the bacteria, or even added neutralization agents or certain precipitation agents to help the precipitation and co-absorption of metal ions from solutions. Further, it is possible to use chemicals to clean the electrodes as described earlier. The medium can be also purified and recirculated water from the outlet of the system or even the same water that is brought in the inlet of the system. All these will serve the purposes of keeping clean the electrode surfaces and controlling the sizes of the microbubbles as described earlier. It is also possible to use electrodes of different materials in the same unit, especially with the construction of FIG. 4. For example, if we have to remove fluorine and some heavy metals from the influent water, the combination of aluminium electrodes (for fluorine) and iron electrodes (for heavy metals) in series construction of FIG. 4 is advantageous.

The auxiliary medium is usually an aqueous solution of the agents that are desired. If electrolytic production of chlorine is not wanted, when the system is not for disinfecting purposes but mainly for separating material by flotation, sodium chloride can be partly or totally replaced with sodium bicarbonate or any other alkali metal bicarbonate in the aqueous solution which is supplied to the electrodes. It has been also found that bicarbonate solution, when used as the auxiliary medium, effectivates the separation of flocculated solids or oily substances on top of the treated liquid in connection with use of iron or other sacrificial anodes as electrodes. The concentration of the alkali metal bicarbonate, for example sodium bicarbonate (NaHCO₃) in the auxiliary medium is preferably 5 to 9 wt-%. The desired effect can be achieved by adjusting volumetric ratio of the auxiliary medium and the treated liquid.

### Example

Waste water from a car wash operation, which contains oil and fat residues, suspended particles and metal residues as microparticles and in dissolved form, is treated with the apparatus of FIG. 2. The apparatus contains four electrodes of type in FIG. 1 made of iron. The dimensions were as follows: Width 150 mm, height 600 mm, hollow spacing in the electrode 8 mm and the interelectrode distance was 15 mm. The capacity used was 80 L/h (L=liter). Part of the purified water after the separation of the flock was circulated through the pockets 6 in the electrodes of FIG. 1. The amount of the circulated water was 10 L/h. The electrodes were connected in parallel and the current was 31 A which means 68.8 A/m2. Peristaltic pumps were used to meter the flows and to cause the pulsating effect for the flows. A hole for the semiconductor pressure detector was made to indicate the pressure variations in the pockets 6 in each of the electrodes. The pulsating pressure varied cyclically between 8 to 17 kPa, which was earlier found to cause sufficient turbulence and mixing between the electrodes. The outlet of the reactor was conducted to a separate tank where the flock and water were separated by skimming. The water phase was clear and the flock was clearly oily. Analysis data of the influent and effluent water phases are in Table 1.

TABLE 1

| | Influent waste | | |
|---|---|---|---|
| | water (mg/L) | Effluent water | Reduction (%) |
| Oil and Grease | 167.3 | 1.4 | 99.2 |
| Metals, total: | | | |
| Al | 6.44 | 0.157 | 97.6 |
| As | 0.025 | 0.0040 | 84 |
| Cd | 0.0054 | 0.0009 | 83 |
| Cr | 0.013 | 0.0033 | 75 |
| Pb | 0.053 | 0.002 | 96.2 |
| Cu | 0.298 | 0.031 | 89.5 |
| Zn | 0.435 | 0.076 | 99.6 |

In FIGS. 2, 3 and 4 the apparatus was shown where the electrodes were in fixed locations in the container or tank, through which the liquid to be treated was pumped so that the liquid flowed in the tank from the inlet to the outlet along a treatment path determined by the location of the electrodes.

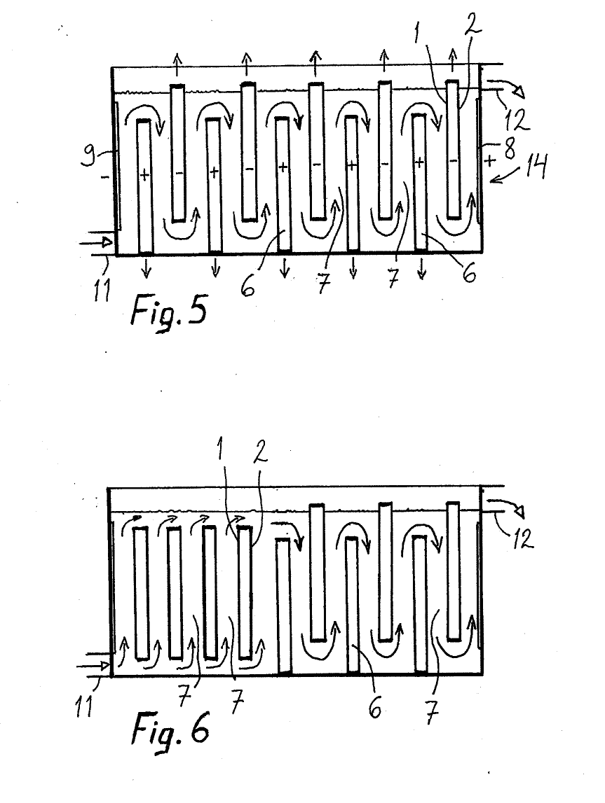

FIG. 5 shows the possibility to transform the container or tank 14 from parallel flow of FIG. 2 (where the liquid moves simultaneously through adjacent passages upwards) to the serial flow of FIG. 4 (where the liquid flows consecutively through adjacent passages so that in every other passage the flow is upwards and in every other passage it is downwards). The construction of the electrode packages made of the plates 1, 2 is in main principles the same as in FIGS. 1 to 4 with the hollow interior 6 left between the plates for introducing the auxiliary medium, but the electrodes are not fixedly attached to the walls 10 to complete the casing. Instead, the open narrow vertical gaps left on both sides of the electrode plates are closed with side walls attached to the electrode plates but movable in respect to the tank walls 10 so that the electrode is movable in vertical direction in the tank or container as an integral closed package. The opposite vertical walls 10 of the tank or container 14 can be provided with grooves or guides to accommodate slidingly the edge of the electrode so that the passages 7 left between the electrodes inside the tank or container are sealed at the sides. The electrodes can be moved vertically in the container or tank 14 and secured to different positions. The auxiliary medium can be introduced to the hollow space 6 between the electrode plates 1, 2 through a hose introduced to the upper corner of the electrode from above, or the holes 13 in the tank wall 10 can be maintained for introducing the auxiliary medium and the side wall of the electrode can have holes in various vertical positions which can be plugged except the hole that is aligned with the hole 13 in the tank wall 10 in the adjusted operative position of the electrode to be in communication with the supply of the auxiliary medium.

In FIG. 5 the inlet of the tank or container 14 is denoted with reference numeral 11. The movements of the electrodes in vertical direction from the parallel flow pattern to the serial flow pattern are denoted with arrows. Every other electrode is moved up to emerge above the liquid level which is determined by the location of the outlet 12 which acts as a sort of overflow, and the rest of the electrodes between them are moved downwards in contact with the bottom of the tank or container 14 to close the horizontal flow at the bottom. This will create a long continuous flow path, “labyrinth”, through the tank from the inlet 11 until the outlet 12 where the flow takes place through successive vertical passages 7 between the electrodes. This mode is preferred if small amounts are treated with long residence times or different agents are supplied along the path from the electrodes to carry out successive treatments in the tank or container 14.

Another possibility to switch the container or tank 14 from a parallel flow mode to the serial flow mode is to lower every other electrode so that their lower edges come in sealing contact with the bottom, but leave the remaining electrodes in their positions where their lower edges are clear of the bottom for leaving a gap for the liquid to pass. The location of the outlet 12 can be adjustable in vertical direction so that the liquid level in the tank or container 14 can be lowered below the upper edges of the remaining electrodes.

In FIG. 6 the modification from parallel mode to the serial mode is made only in the last section of the tank or container 14, the section which is close to the outlet 12, and in the initial section the electrodes are left in their original vertical positions. In the initial section the linear flow velocity in the passages 17 is slow and in the last section the linear flow velocity increases. By rearranging the electrodes the situation can also be reversed so that the initial section operates in a serial flow mode and the last section in a parallel flow mode. Many other variation possibilities also exist.

FIG. 7 shows a possibility to remove mechanically the material separated during the treatment process in the tank or container 14. The outlet 12 is connected to a clarification container 15, where the material separated on the surface or sedimented in the bottom is removed from the liquid. If the apparatus works in the parallel flow mode and the electrodes are submerged in the liquid, the material separated on the liquid surface can also be removed already in the container or tank 14 mechanically using a drag 16 that sweeps or skims the liquid surface, such as a drag conveyor. The drag can skim the separated material horizontally along the liquid surface till the outlet 12 through which the material can enter the clarification container or to a discharge. Alternatively, the material can be removed from the liquid surface through suction using an extractor 17 which can be made movable to various positions above the tank (shown by broken lines). Conveyor screws on the bottom and on the side wall of the clarification container 15 that remove and lift solid settled material from the bottom are denoted with reference numeral 18.

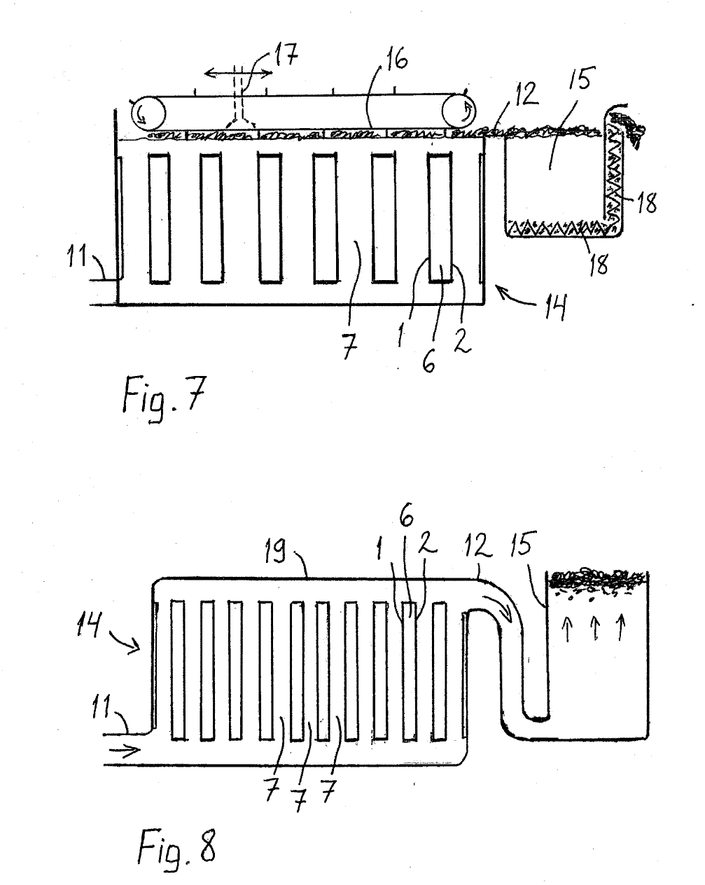

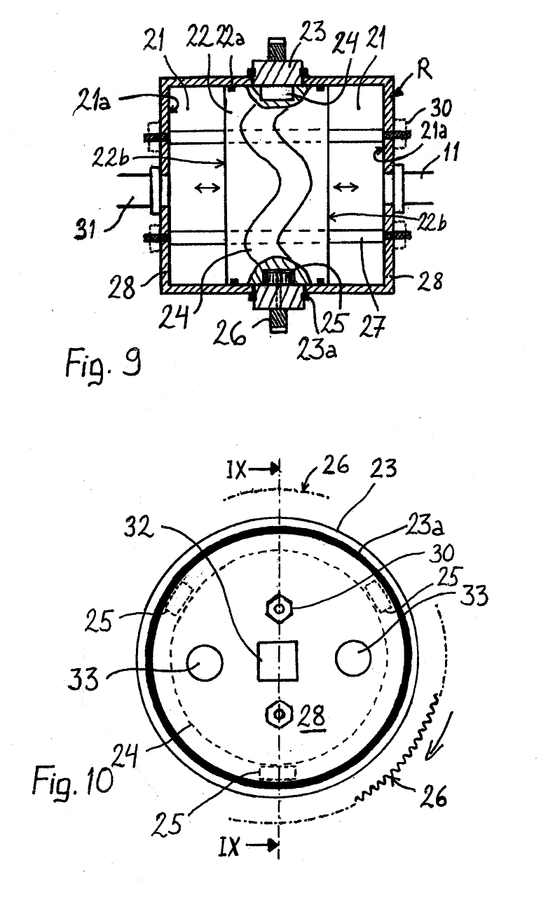

The tank or container 14 shown in the previous drawings is open at the top and it has walls and bottoms for retaining the desired volume of the liquid to be treated. FIG. 8 shows as example that the container or tank 14 can also be totally encapsulated in which case it has a cover 19. The cover can have outlets for controlled exit of gases that are separated during the electrolytic process. In other respects the apparatus can have the same functions as described above, except that the surface of the liquid is not easily accessible for mechanical removal of the separated material. The outlet 12 is connected by a conduit to the bottom part of the clarification container 15. The material separated during the process in the tank or container 14 will rise to the surface of the clarification container 15 from where it can be removed.

In all apparatuses presented above, the material of the electrodes can be chosen according to the electrolytic process that is to be performed. In separating fats, oils or metals, in general treating waters contaminated with oils, fats and heavy metals, electrodes made of iron can be used. If the aim is oxidative treatment, for example disinfection of water, platinum plated titanium plates or rhodium oxide plated titanium plates can be used as electrodes. However, these examples are nor intended as exhaustive. The electrodes in the tank or container 14 can also be mixed if different types of treatments are to be performed on the contaminated water or wastewater.

FIGS. 9, 10 and 11 illustrate a pump type that can be used both as the main pump for accomplishing the main flow and the auxiliary pump for achieving the flow of the conductivity enhancing medium through the electrodes. The pump can have a similar construction as described in Finnish Patent no. 120751 of the Applicant, the disclosure of which is incorporated herein by reference.

The pump shown by FIG. 9 comprises a pumping chamber 21, where a piston 22 is arranged in reciprocating motion. A ring 23 surrounds the piston with the inner surface of the ring facing the outer surface of the piston. An endless guide 24 extends along the periphery of the piston around the piston. The guide has such waveform where the peaks and bottoms of the waves alternately deviate from the peripheral direction to the directions of the reciprocating motion of the piston. The waveform can be a sine wave, but this is not necessary. Fixed to the ring 23 on its inner side there is a countermember 25 cooperating with the guide 25, as a sort of cam in contact with the waveform. The axial reciprocating motion of the piston 22 (pumping motion) is guided by linear guides 27 which are in fixed position with respect to the pumping chamber 21. In FIG. 9 the guides 27 are guide rods introduced through the piston 22.

The piston acts in the following manner: When the ring 23 is brought to a rotating motion around the piston with the direction of the movement being coincident with the direction of the outer periphery of the piston, the countermember 25 of the ring travels along the similar motion path which is rectilinear with regard to the waveform guide 24, urging at the same time the piston 22 successively to the left and to the right as it moves along in the waveform guide, thus creating the pumping motion. This pumping motion is due to the distance between the front face 22b of the cylindrical piston 22 and the opposite end wall 21a of the cylindrical pumping chamber 21 increasing and decreasing in an alternating (pulsating) manner. By this arrangement, the pumping motion could be in principle be achieved in one single pumping chamber 21 only. Because the both front faces of the piston perform reciprocating movement on both sides of the piston being one integral piece, it is advantageous to arrange a pumping chamber 21 on both sides as shown by FIG. 1. As the piston 22 moves in one direction, the volume of the pumping chamber 21 on one side is decreasing (pressure phase) and the volume of the pumping chamber 21 on the opposite side is increasing (suction phase).

As shown by FIG. 9, the guide 24 is an undulating groove made on the outer side of piston 22. The countermember 25 is in turn a part protruding on the inner surface of the ring 23 and received inside the said groove. To lower the friction this protruding part is preferably rotatable, and the figure shows, how the part is a disc journalled rotatably on the inner side of the ring 23, the axis of rotation being in radial position with respect to the piston. Such a rotating countermember utilizing rolling friction can also be accomplished by a technique known from ball bearings, that is, the countermember 25 can also be spherical and the groove can have a cross-sectional shape that matches the spherical shape.

When the waveform, that is, the form of the undulating groove, is a sine wave, the piston 22 will perform its strokes to both opposite directions in accordance with the amplitude of the sine wave and consequently, its linear speed will change concurrently with the change of amplitude of the sine-wave along the x-axis which in this case coincides with the direction of periphery of the piston. Thus, when the piston leaves its rearmost position in the pumping chamber and starts its work stroke, its speed is first low, it then accelerates to full speed and decelerates again to lower speed before the foremost point of its front face. At this point the front face on the opposite side of the piston is in its rearmost position in its pumping chamber, and the above-described work stroke that follows the sine wave pattern is repeated, now in the opposite direction. This varying linear speed during the successive strokes of the piston creates slight pulsation in the volumetric flow out of the pump which is the result of these successive strokes. This will be seen in the flows occurring in the apparatus as high-frequency variations in the flow speed which is continuous, the frequency being dependent on the rotation speed of the ring 23.

If a supply of more pulsating character is desired, the pump can be used with one pumping chamber 21 only as the pressure chamber for the medium or water. In this case the supply is stopped during the suction phase when the piston retracts and the pumping chamber is being filled with new volume. It is also possible to connect the opposite sides of the piston 22, that is, the opposite pumping chambers 21 with a channel inside the piston. This channel comprises a check valve allowing the passage to one direction only. One of the chambers 21, the chamber to which the check valve allows the flow, is always a pumping chamber and the other chamber 21 on the opposite side of the piston is always the suction chamber.

The FIG. 9 also shows annular seals 22a on the peripheral surface of the piston 22. The seals lie against the side surfaces of the pumping chambers 21. Moreover, seals 23a are arranged between the ring 23 and the pump body R. These seals are fixed to the side walls of the ring 23 and they seal the joint between the body R and the rotating ring 23 on the outside of the body.

In FIG. 9 gear teeth provided on the outer periphery of the ring 23 are denoted with reference numeral 26. Through this toothed construction power can be transmitted to the ring 23 for example using a chain or gear wheel. The gear teeth may be formed integrally in the same piece of which the ring 23 is made. Reference numeral 31 denotes fastening means which can be used to secure the whole body R non-rotatable to some support structure to prevent its rotation together with the rotative motion of the ring 23.

As shown by FIG. 9, the pump body R is formed of two cup-like halves which are connected in abutment with the side surfaces of the ring 23 on opposite sides with such a clearance that the ring is able to rotate in between. These cup like parts form each the corresponding pumping chamber 21. The interior where the piston 22 moves slidingly in its entirety is thus constituted of the cylindrical inner surfaces of the cup-like parts and the inner surface of the ring 23 which is located between the halves. The body R is assembled together by means of rods 27 which are fixed to the end walls of the cup-like halves such that their threaded ends are inserted through the holes in the corresponding end wall and secured by nuts 30 denoted with broken lines. The rods 27 act at the same time as guides for the axial movement of the piston 24 in the manner described hereinabove.

FIG. 10 shows the pump of FIG. 9 in an end view. The construction is similar to the shown one in the opposite end too. The end wall comprises a square-shaped opening 32 for fixing the fastening means 31, but it can have another shape as well. Fastening means of another type can also be used, such as flanges made on the outer surface of the end wall. Figure also shows openings 33 for the pumpable medium, both of which are in turns inlet openings or outlet openings for the medium, depending on the phases of the piston. The groove constituting the guide 24 and the countermembers 25 received therein are denoted by broken lines.

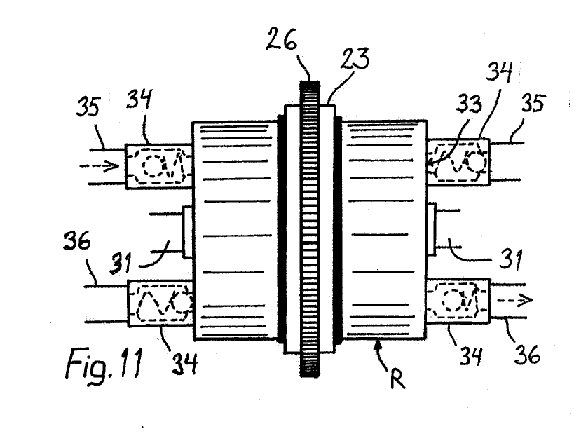

FIG. 11 shows the pump of FIGS. 9 and 10 in a top view. The figure shows a situation where corresponding conduits 35, 36 are sealingly connected to the openings 33 in both ends. Each conduit contains a valve 34 that allows the flow to one direction only, for example a check valve. At both ends (at each pumping chamber 21) the valves are arranged in pairs where the valves have different pass directions. As shown by FIG. 11, in the forward stroke phase of the piston to the right, one valve 44 in the valve pair of the right hand side shuts off the flow to the inlet conduit 35 and the liquid volume pushed by the piston enters the outlet conduit 36 through the other valve 44, whose pass direction is away from the pumping chamber 31. On the opposite side, that is, on the left hand side, which is under suction phase, only that of the valves, 34, whose pass direction is from the inlet conduit 35 to the chamber 21, allows the flow to pass (the upper valve in FIG. 11) while the flow from the outlet conduit 36 is blocked by the other valve (the lower valve in FIG. 11).

The guide could be in the inner surface of the ring-like structure 23 and the countermember engaging it on the outer surface of the piston 22, but because the guide that determines the reciprocal movement has to possess a sufficient amplitude in the axial direction (stroke direction) of the piston, it is most feasible solution to provide the guide on the periphery of the piston so that the ring need not be made too wide. In FIG. 9, the guide 24 on the piston comprises most preferably three full waves (that is, in total six deviations to both directions) in one revolution. Thus, each front surface 22b of the piston will perform three full cycles (suction+pressure phases) during one revolution of the ring 23. The desired stroke length of the piston can be achieved by the axial amplitude of the guide waveform.

When the inlet conduits 35 from the same location and the outlet conduits 36 to the same location are connected pairwise to different sides of the pump, the capacity can be doubled, because during each full cycle of the reciprocal movement of the piston the piston pushes medium from a pumping chamber twice, both during the advancing movement in one direction from a first chamber and during the advancing movement to the opposite direction from a second chamber, when the piston retracts with respect to the first chamber.

The gear teeth 26 around the ring 23 are not the only means to transmit power to the pump to bring the ring 23 to rotation. Also other transmission arrangements, such as V-belt drive can be used. The number of countermembers 25 is preferably two or more, divided equidistantly (at equal angular distances) on the periphery of the piston 22, for example three spaced at intervals of 120° as shown in FIG. 10.

Because the structure of the pump is symmetrical, the operation of the pump is not dependent on the rotation direction of the ring, but it will pump the medium in the same way and in the same rate regardless of the rotation direction.

The pump of the FIGS. 9 to 11 can be used both as the pump providing the main flow of the water to be treated through the apparatus and the pump providing the flow of the auxiliary medium to the electrodes, it being understood that pumps of different capacities must often be used for the different flows.

It will be appreciated that the embodiments of the invention which are described above with reference to the accompanying drawings are merely illustrative of ways of putting the invention into effect and should not be seen as limiting on the overall scope of the invention.

I claim:

1. Method for electrochemical treatment of contaminated water or wastewater, comprising:
introducing water through an inlet to a container or tank;
causing the water to pass in the container or tank along a flow route between the inlet and an outlet of the container or tank, said flow route being partly defined by vertical passages between vertical pairs of electrode plates;
causing the water to pass at least in part of said flow route upwards in said vertical passages;
introducing auxiliary medium into empty spaces between the electrode plates in the vertical pairs of electrode plates;
introducing said auxiliary medium from the empty spaces to said vertical passages through at least one electrode plate in the pairs of electrode plates while the water passes in said vertical passages;
when introducing water through the inlet and the auxiliary medium into the empty spaces between the electrode plates, using pulsating supply of at least one of the water and the auxiliary medium,
leading out the water that has flowed along the route in the container or tank through the outlet; and
removing water-insoluble solids or liquid separated in the electrochemical treatment from surface or bottom of the water.

2. The method according to claim 1, wherein water is introduced through the outlet to a clarification container, where water-insoluble solids or liquid is removed from surface or bottom of the water.

3. The method according to claim 1, wherein water-insoluble solids or liquid is removed in the container or tank above the pairs of electrode plates by conveying mechanically or by suction.

4. The method according to claim 1, wherein the water passes in the vertical passages alternately upwards and downwards in such a manner that the water is subjected to serial treatment in adjacent passages.

5. The method according to claim 1, wherein the water passes in adjacent vertical passages simultaneously upwards in such a manner that the water is subjected to parallel treatment in adjacent passages.

6. The method according to claim 4, wherein the water is subjected to parallel treatment and serial treatment in the vertical passages in succession in the same container or tank.

7. The method according to claim 6, wherein the serial treatment follows the parallel treatment in the flow route.

8. The method according to claim 6, wherein the parallel treatment follows the serial treatment in the flow route.

9. The method according to claim 1, wherein the auxiliary medium is introduced to said vertical passages from the empty spaces formed between electrode plates of same electric charge in the pairs of electrodes.

10. The method according to claim 1, wherein the auxiliary medium comprises bicarbonate.

11. Apparatus for electrochemical treatment of contaminated water or wastewater, comprising:
a container or tank having an inlet and an outlet
a feed pump for the water to be treated, connected to the inlet for supplying the water through the inlet to the container or tank;
parallel pairs of electrode plates situated in vertical position in the container or tank and forming parallel vertical passages therebetween for the water to be treated, said passages forming a flow route for the water between the inlet and the outlet,
in the pairs of electrode plate, in at least one electrode plate holes connected to a feed pump for an auxiliary medium,
said pairs of electrode plates being positioned between the inlet and outlet in the container or tank such that in at least part of the flow route between the inlet and outlet the water passes upwards in said vertical passages,
the feed pump for the water to be treated and/or the feed pump for the auxiliary medium being a pulsating feed pump.

12. The apparatus according to claim 11, wherein electrode plates limiting two adjacent vertical passages form an empty closed space which is connected to the feed pump for the auxiliary medium.

13. The apparatus according to claim 11, wherein it comprises a clarification container placed after the outlet and comprising means for removing water-insoluble solids or liquid from the surface of water or from the bottom of the water.

14. The apparatus according to claim 11, wherein it comprises a drag or an extractor above the container or tank for removing material by mechanical movement or suction, respectively, from the surface of water.

15. The apparatus according to claim 11, wherein the outlet of the container or tank is located higher that the inlet of the container or tank.

16. The apparatus according to claim 11, wherein at least part of the pairs of electrode plates are movable in vertical direction in the container or tank and positionable against the bottom of the container or tank for altering the flow route between the inlet and outlet.

17. The apparatus according to claim 16, wherein a closed empty space is formed between the electrode plates in the pair of electrode plates, said closed empty space being movable together with the pair of electrode plates in vertical direction.

18. The apparatus according to claim 11, wherein the feed pump comprises:
a piston placed for linear reciprocating movement in a pumping chamber and comprising a periphery extending around the piston in a direction perpendicular to the reciprocating movement;
a driving ring-like structure placed around the periphery of piston and arranged rotatable with respect to the piston around the periphery of the piston;
a mechanism between the ring-like structure and the piston for transforming the rotating movement of the ring-like member to a linear reciprocating movement of the piston, said mechanism comprising a first part on an inner side of the ring-like structure and moving along with the movement of the ring-like structure and a second part on the periphery of the piston and moving along with the movement of the piston, said first part engaging said second part in a motion transforming manner, one part of said first part and second part being an endless waveform guide extending in the direction of the periphery of the piston, and the other part of said first part and second part being a countermember engaging said endless waveform guide so as to transform the rotating movement of the ring-like member into the linear reciprocating movement of the piston.

19. The apparatus according to claim 18, wherein the countermember is on the inner side of the ring-like member and the endless waveform guide is on the periphery of the piston.

20. The apparatus according to claim 18, wherein the piston is a double-acting piston with its both opposite ends in different pumping chambers, said driving ring-like structure extending around the periphery of the piston between the different pumping chambers.
